(19) United States
(12) Patent Application Publication
(10) Pub. No.: US 2024/0266539 A1
(43) Pub. Date: Aug. 8, 2024

(54) NEW ELECTRODE MATERIAL FOR PRINTING POLYMER BATTERIES

(71) Applicant: InnovationLab GmbH, Heidelberg (DE)

(72) Inventors: Vadym BAKUMOV, Marl (DE); Andreas Wild, Haltern am See (DE); Lina Hähnel, Duisburg (DE); Sébastien Cochet, Ratingen (DE)

(73) Assignee: InnovationLab GmbH, Heidelberg (DE)

(21) Appl. No.: 18/258,154

(22) PCT Filed: Dec. 13, 2021
(86) PCT No.: PCT/EP2021/085388

§ 371 Date: Mar. 21, 2024

(30) Foreign Application Priority Data
Dec. 17, 2020 (EP) 20214828.4

(51) Int. Cl. H01M 4/60; H01M 4/62

(52) U.S. Cl. CPC H01M 4/608; H01M 4/622; H01M 4/624

(57) ABSTRACT

The invention relates to an electrode material comprising at least one organic redox-active polymer, at least one conductive additive, and polyvinyl butyral as a binder. The electrode material according to the invention makes it possible to manufacture organic batteries having improved charging and discharging capacities. The invention also relates to electrodes comprising the electrode material as well as to batteries comprising the electrodes. The electrode material can also be used for printing electrodes.

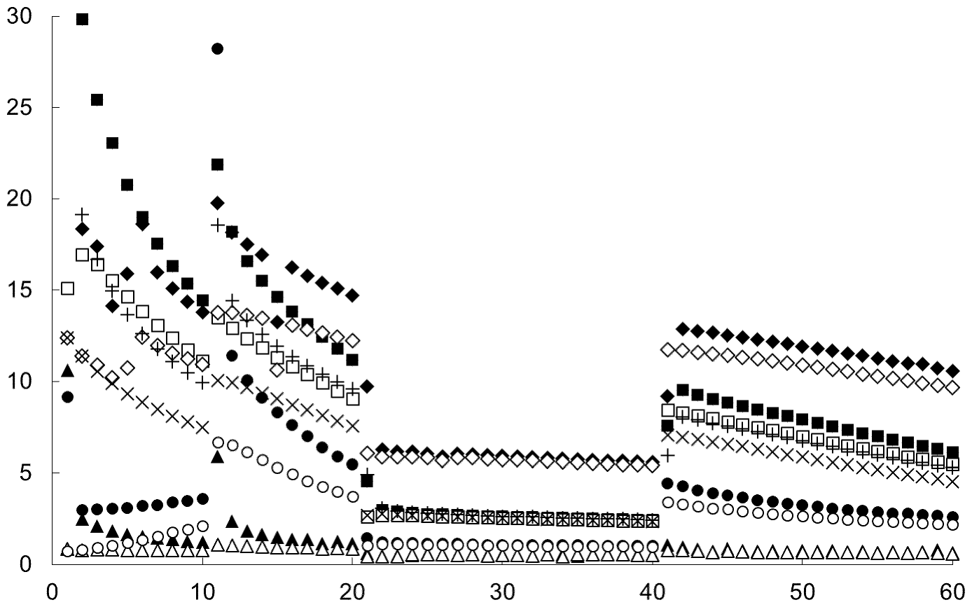

The present invention relates to an electrode material comprising at least one organic redox active polymer, at least one conductivity additive, and polyvinyl butyral as a binder. The electrode material of the present invention enables producing organic batteries with improved charging and discharging capacities. The invention also relates to electrodes comprising the electrode material and batteries comprising the electrodes. The electrode material can also be used for printing electrodes.

### 1. BACKGROUND OF THE INVENTION

Organic batteries are electrochemical cells that use an organic charge storage material as an active electrode material for storing electrical charge. These batteries have many advantages and have a fundamentally different operating mechanism compared to metal-based charge storage materials.

A variety of organic storage materials are described in the literature. An overview of these is given in EP 3 588 634 A1 and in the article S. Muench, A. Wild, C. Friebe, B. Häupler, T. Janoschka. U. S. Schubert. Chem. Rev. 2016, 116, 9438-9484 (hereinafter “Muench et al.”).

In the production of electrodes from these organic storage materials, the electrode material is usually mixed with a conductivity additive, for example a carbon material, and a binder additive (=“binder”) and applied to a substrate. The application of the electrode materials is conducted in many cases by coating or printing. This possibility opens up promising opportunities for the technology of printable batteries.

The obtained electrodes are subsequently assembled with a counter electrode into a battery. The construction of such a battery is known to those skilled in the art, as described, for example, by Muench et al. A large number of electrolytes can be incorporated in these batteries, including metal salts (e.g. lithium salts), solid electrolytes (WO 2020/126200 A1) or ionic liquids (S. Muench, R. Burges, A. Lex-Balducci, J. C. Brendel, C. Friebe, A. Wild, U.S. Schubert, Energy Storage Materials 2020, 25, 750-755).

Although the obtained electrodes have good capacitances, there is still a need in this technical field to improve the capacities of electrodes based on organic charge storage materials.

The object of the present invention is therefore to provide a preferably printable, preferably gravure-printable, electrode material with which organic electrodes and batteries with high charge and discharge capacity can be produced.

### 2. BRIEF DESCRIPTION OF THE INVENTION

The object was achieved in that polyvinyl butyral (hereinafter “PVB”) was incorporated as binder in the electrode material. The electrode material of the present invention surprisingly enables producing organic batteries with improved charging and discharging capacities, compared to conventional batteries based on binders, such as those described in WO 2017/207325 A1 or WO 2018/046387 A1 and cellulose-based. This electrode material is particularly characterized in that it can be incorporated in printing processes, preferably in gravure printing processes.

Thus, in a first aspect, the present invention relates to an electrode material comprising:
(i) at least one organic redox active polymer P_{Redox},
(ii) at least one conductivity additive L,
(iii) at least one binder B.
(iv) optionally at least one ionic liquid IL₁,
characterized in that
the binder B comprises at least one polymer P_{B1} which comprises a repeating unit of the following structural formula (I):

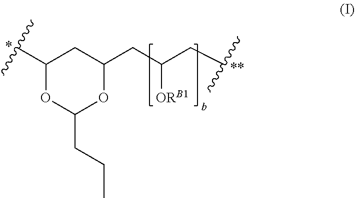

wherein R^{B1} is hydrogen or acetyl,
is an integer ≥10,
b is an integer ≥0,
and wherein the bond marked by “*” binds a repeating unit of the structural formula (I) to the bond marked by “**” of the adjacent repeating unit of the structural formula (I), and the repeating units of the structural formula (I) comprised by the polymer P_{B1} are identical or different from each other.

In a second aspect, the present invention relates to an electrode comprising the electrode material according to the invention.

In a third aspect, the present invention relates to a charge storage device comprising at least one electrode according to the invention.

In a fourth aspect, the present invention relates to the use of the electrode material according to the invention as an ink in printing processes.

### 3. DETAILED DESCRIPTION OF THE INVENTION

### 3.1 Organic Redox Active Polymer P_{Redox}

The electrode material according to the invention comprises at least one organic redox active polymer P_{Redox}.

Organic redox active polymers P_{Redox} are known to a person skilled in the art and are described, for example, in US 2016/0233509 A1, US 2017/0114162 A1, US 2017/0179525 A1, US 2018/0108911 A1. US 2018/0102541 A1, WO 2017/207325 A1, WO 2015/032951 A1. A review of further usable organic redox active polymers gives Muench et al.

The organic redox active polymer P_{Redox} can be obtained according to methods known to the person skilled in the art. The corresponding methods are summarized by Muench et al. In addition, the synthesis of the organic redox active polymers P_{Redox} comprising a redox active aromatic imide function, e.g. phthalimide function, is described in WO 2015/003725 A1 and U.S. Pat. No. 4,898,915 A.

In addition, organic redox active polymers P_{Redox} comprising a redox active aromatic function comprising at least one stable oxygen moiety or at least one stable oxygen moiety are known to the person skilled in the art, or the synthesis of the corresponding organic redox active polymers P_{Redox} from WO 2017/207325 A1, EP 1 752 474 A1, WO 2015/032951 A1, CN 104530424 A, CN 104530426 A, T. Suga, H. Ohshiro, S. Sugita. K. Oyaizu, H. Nishide, Adv Mater. 2009, 21, 1627-1630 und T. Suga. S. Sugita, H. Ohshiro. Oyaizu H. Nishide, Adv. Mater. 2011, 3, 751-754.

In addition, the synthesis of organic redox active polymers P_{Redox} comprising a redox active anthraquinone/carbazole—function and the synthesis of the organic redox active polymers P_{Redox} comprising a redox active Benzoquinone function is also routinely possible in or for a person skilled in the art on the basis of his knowledge from WO 2015/132374 A1, WO 2015/144798 A1, EP 3 279 223 A1, WO 2018/024901 A1, US 2017/0077518 A1, US 2017/0077517 A1. US 2017/0104214 A1, D. Schmidt, B. Häupler, C. Stolze, M. D. Hager, U.S. Schubert, J. Polym. Sci., Part A: Polym. Chem. 2015, 53, 2517-2523, M. E. Speer, M. Kolek, J. J. Jassoy, J. Heine, M. Winter, P. M. Bieker, B. Esser, Chem. Commun. 2015, 31, 15261-15264 und M. Baibarac, M. Lira-Cantú. J. Oró Sol, I. Baltog, N. Casañ-Pastor. P. Gomez-Romero, Compos. Sci. Technol. 2007, 67, 2556-2563.

In addition, the synthesis of organic redox active polymers P_{Redox} comprising a redox active dialkoxybenzene function is also described in WO 2017/032583 A1, EP 3 136 410 A1. EP 3 135 704 A1, WO 2017/032582 A1, P. Nesvadba, L. B. Folger, P. Maire, P. Novak, Synth. Met. 2011, 161, 259-262; W. Weng, Z. C. Zhang, A. Abouimrane, P. C. Redfern, L. A. Curtiss. K. Amine, Adv. Funct. Mater. 2012, 22, 4485-4492.

In addition, the synthesis of organic redox active polymers P_{Redox} comprising a redox active triphenylamine function is also described in JP 2011-74316 A, JP 2011-74317 A.

In addition, the synthesis of organic redox active polymers P_{Redox} comprising a redox active viologen function is also described in CN 107118332 A and N. Sano, W. Tomita, S. Hara. C.-M. Min, J.-S. Lee, K. Oyaizu. H. Nishide. ACS Appl. Mater. Interfaces 2013, 5, 1355-1361.

In addition, the synthesis of organic redox active polymers P_{Redox} comprising a redox active ferrocene function is also described in K. Tamura. N. Akutagawa, M. Satoh, J. Wada, T. Masuda. Macromol. Rapid Commun. 2008, 29, 1944-1949.

According to the invention, the at least one organic redox active polymer P_{Redox} is in particular selected from the group consisting of polyimides and organic redox active polymers comprising m repeating units of the following structural formula (II), preferably from organic redox active polymers comprising m repeating units of the following structural formula (II):

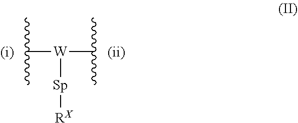

wherein m is an integer ≥4, in particular an integer ≥10, preferably an integer ≥100, more preferably an integer ranging from 100 to 10⁹ more preferably an integer in the range of 100 to 10⁶ more preferably an integer in the range of 100 to 10⁴, more preferably an integer in the range of 100 to 2000,
W is an organic unit,
Sp is an organic spacer,
and R^{X} is an organic redox active group,
and wherein the bond marked by “(i)” binds a repeating unit of the structural formula (II) to the bond marked by (ii)” of the adjacent repeating unit of the structural formula (II),
and the repeating units of the structural formula (II) comprised by the organic redox active polymer P_{Redox} are the identical or different from each other.

R^{X} in the structure (II) is preferably selected from the group consisting of the following structural formulae (II-A), (II-B), (II-C), (II-D), (II-E), (II-F), in particular (II-A), (II-B), (II-D), (II-E), (II-F), preferably (II-A), (II-B), (II-D), (II-E), more preferably (II-D), (II-E), even more preferably (II-D):

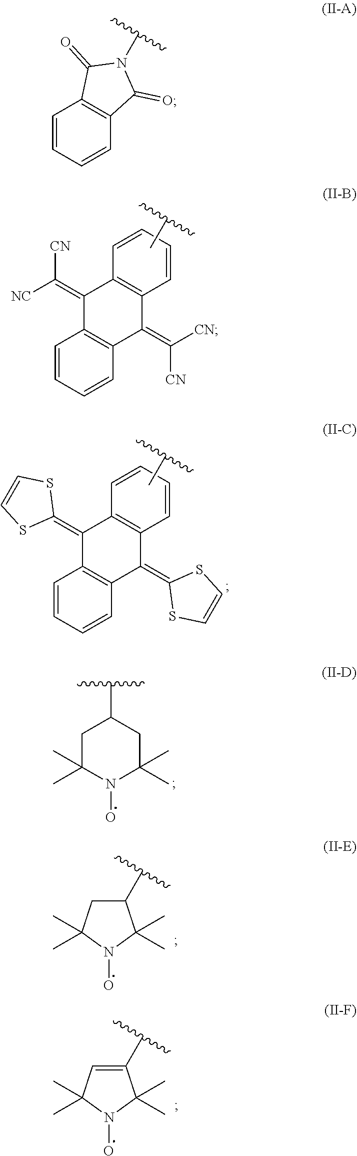

wherein, in the structural formulae (II-A), (II-B) and (II-C), at least one aromatic carbon atom can be substituted with a group selected from alkyl groups, which comprise in particular 1 to 10 carbon atoms, halogen group, alkoxy group, which comprise in particular 1 to 10 carbon atoms, hydroxy group.

W in the structure (II) is an organic unit, and a person skilled in the art can select these on the basis of his knowledge. The organic spacer Sp binds the redox active unit R^{X} and the organic unit W and can likewise be routinely selected by a person skilled in the art on the basis of his knowledge.

The organic unit W in the structure (II) is in particular selected from the group consisting of the structures (W1), (W2), (W3), preferably (W1), (W2), more preferably (W1):

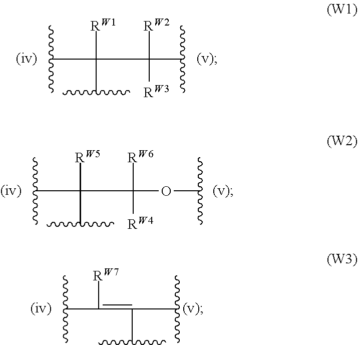

wherein, in the organic redox active polymer P_{Redox} each of the bond marked by “(iv)” binds a structural formula (W1), (W2), (W3) to the bond marked by “(v)” of the adjacent structural formula (W1), (W2) or (W3).
and wherein each bond marked by “(iii)” marks the bond to Sp,
wherein R^{W1}, R^{W2}, R^{W3}, R^{W4}, R^{W5}, R^{EW6}, R^{W7} are each independently selected from the group consisting of hydrogen, alkyl group, haloalkyl group, —COOR^{W8}R^{W8}=H or alkyl, preferably from the group consisting of hydrogen, alkyl group, —COOH, —COOCH₃, more preferably from the group consisting of hydrogen, alkyl group with 1 to 6 carbon atoms, —COOH, —COOCH₃, more preferably from hydrogen, methyl group, —COOH, —COOCH₃, more preferably from hydrogen, methyl,
wherein the unit W in the structural formula (II) in particular preferably has the structural formula (W1) and then more preferably R^{W1}=H or methyl, R^{W2}, R^{W3}=H, even more preferably R^{W1}=methyl, R^{W2}, R^{W3}=H,
and wherein Sp, in the structure (II), is selected from the group consisting of direct bond, (Sp1), (Sp2), preferably direct bond. (Sp2), more preferably (Sp2):

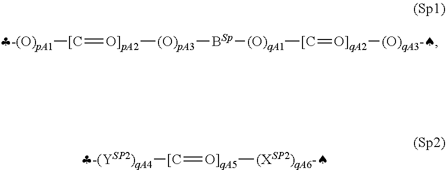

wherein pA1, pA2, pA3 are each 0 or 1, wherein the case “pA2=0, pA1=pA3=1” is excluded,
wherein qA1, qA2, qA3 are each 0 or 1, wherein the case “qA2=0, qA1=qA3=1” is excluded,
wherein qA4, qA5, qA6 are each 0 or 1, wherein at least one of qA4, qA5, qA6=1 and wherein the case “qA5=0, qA4=qA6=1” is excluded,
wherein X^{SP2}, Y^{SP2} are each independently NH or O, preferably both are O,
wherein B^{Sp} is selected from the group consisting of
divalent (hetero)aromatic moiety,
divalent moiety, optionally with at least one group selected from nitro group, —NH₂, —CN, —SH, —OH, halogen-substituted, and optionally with at least one group selected from ether, thioether, aminoether, carbonyl group, carboxylic acid ester, carboxylic acid amide group, sulfonic acid ester, phosphoric acid ester having an aliphatic moiety.
wherein B^{SP} is preferably phenylene, alkylene, more preferably phenylene, alkylene with 1 to 10, more preferably 1 to 6, carbon atoms,
and wherein, in the cases in which Sp binds to an atom of the moiety R^{X} different from carbon, for the structure (Sp1), the additional condition “qA3=0, qA2=1, qA1=1 or qA3=qA2=qA1=0 or qA3=0, qA2=1, qA1=0” applies, and for the structure (Sp2) the additional condition “qA6=0, qA5=1, qA4=1 or qA6=0, qA5=1, qA4=0” applies,
and wherein, in the cases in which Sp binds to a carbon atom of the moiety R_{X}, for the preferred structure (Sp2), “qA6=1, qA5=1, qA4=0” applies,
and wherein “ [symbol] ” marks the bond pointing to R^{X},
and wherein “ [symbol] ” marks the bond pointing to W.

It is to be noted that the condition “wherein at least one of qA4, qA5, qA6=1” for (Sp2) refers only to the definition of the respective variables qA4, qA5, qA6 and does not exclude that the moiety Sp in the structural formula (II) can also be a direct bond.

More preferably, the moiety Sp is selected from the group consisting of direct bond, [symbol] —[C═O]—(O)— [symbol] , [symbol] —[C═O]—(NH)— [symbol] , more preferably selected from the group consisting of direct bond, [symbol] —[C═O]—(O)— [symbol] , wherein “ [symbol] ” marks the bond pointing to R^{X}, and wherein “ [symbol] ” marks the bond pointing to W. Most preferably, the moiety Sp is a group of the structure [symbol] —[C═O]—(O)— [symbol] , wherein “ [symbol] ” marks the bond pointing to R^{X}, and wherein “ [symbol] ” marks the bond pointing to W.

In another preferred embodiment of the electrode material according to the invention, the organic redox active polymer P_{redox} is a polyimide which comprises n repeating units selected from the following structural formulae (III-A), (III-B), (III-C), (III-D), in particular (III-C) and (III-D), preferably (III-D):

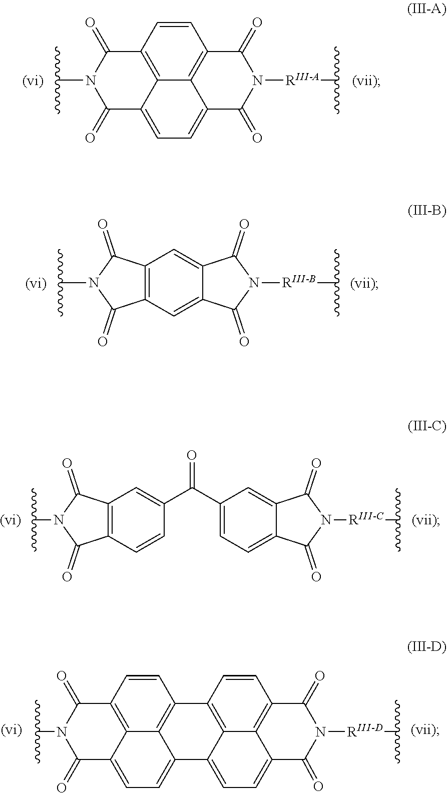

wherein R^{III-A}, R^{III-B}, R^{III-C}, R^{III-D} are each independently selected from the group consisting of direct bond, carbonyl group, alkylene group, divalent aromatic hydrocarbon group, wherein the alkylene group can be interrupted by a carbonyl group,
and wherein, in the structural formulae (III-A), (III-B), (III-C), (III-D), at least one aromatic carbon atom can be substituted with a group selected from alkyl, halogen, alkoxy, OH,
and wherein each n is an integer ≥4, preferably an integer ≥10, more preferably an integer ≥100, even more preferably an integer ranging from 100 to 10⁹, even more preferably an integer ranging from 100 to 10⁶, even more preferably an integer ranging from 100 to 10⁴, even more preferably an integer ranging from 100 to 2000,
and wherein the bond marked by “(vi)” binds a repeating unit of the structural formula (III-A), (III-B), (III-C), or (III-D) each to the bond marked by “(vii)” of the adjacent repeating unit.

In particular, R^{III-A}, R^{III-B}, R^{III-C}, R^{III-D} are each independently selected from the group consisting of direct bond, carbonyl group, alkylene group with 1 to 10, preferably 1 to 6, more preferably 1 to 2 carbon atoms, phenylene, tolylene, 4,4′-methylenebis (phenylene).

In a preferred embodiment of the electrode material according to the invention, the at least organic redox active polymer P_{Redox} is selected from the group consisting of polymers comprising m repeating units of the following structural formulae (IV-1), (IV-2), (IV-3), (IV-4),

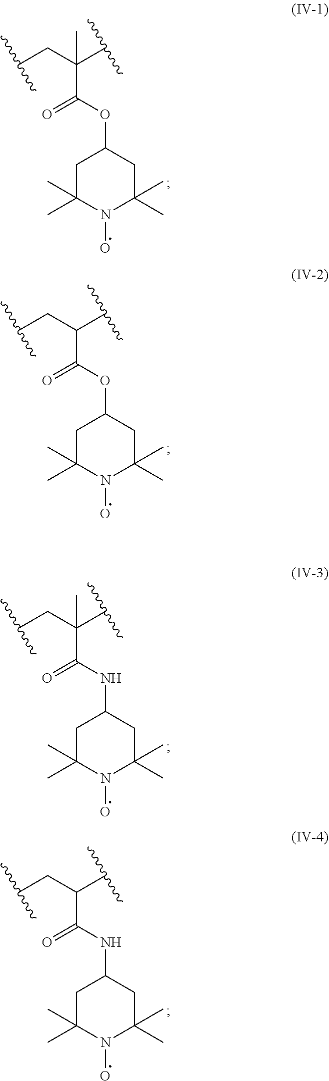

wherein m is an integer ≥4, in particular an integer ≥10, preferably an integer ≥100, more preferably an integer ranging from 100 to 10⁹, more preferably an integer in the range of 100 to 10⁶, more preferably an integer in the range of 100 to 10⁴, more preferably an integer in the range of 100 to 2000,
and further consisting of polyimides comprising n repeating units selected from the aforementioned structural formulae (III-A), (III-B), (III-C), (III-D), preferably (III-C), or (III-D) more preferably (III-D), in which R^{III-A}, R^{III-B}, R^{III-C}, R^{III-D} are each independently selected from the group consisting of direct bond, carbonyl group, alkylene group with 1 to 10, preferably 1 to 6, even more preferably 1 to 2 carbon atoms, phenylene, tolylene, 4,4′-methylenebis(phenylene), preferably in which R^{III-A}, R^{III-B}, R^{III-C}, R^{III-D} are each independently selected from the group consisting of direct bond, carbonyl group, alkylene group with 1 to 2 carbon atoms, 2,4-tolylene, 2,6-tolylene, 4,4′-methylenebis(phenylene), preferably in which R^{III-A}, R^{III-B}, R^{III-C}, R^{III-D} are each independently selected from the group consisting of direct bond, carbonyl group, alkylene group with 1 to 2 carbon atoms.

In a particularly preferred embodiment of the electrode material according to the invention, the at least one organic redox active polymer P_{Redox} is selected from the group consisting of m repeating units from the above-described structural formulae (IV-1), (IV-2), preferably (IV-1), wherein m is an integer ≥4, in particular an integer ≥10, preferably an integer ≥100, more preferably an integer ranging from 100 to 10⁹, more preferably an integer in the range of 100 to 10⁶, more preferably an integer in the range of 100 to 10⁴, more preferably an integer in the range of 100 to 2000.

### 3.2 Conductivity Additive L

### 3.2.1 Preferred Conductivity Additives L

The at least one conductivity additive L, which is comprised by the electrode material according to the invention, is at least one electrically conductive material, in particular selected from the group consisting of carbon materials electrically conductive polymers, (semi) metals, (semi) metal compounds, preferably selected from carbon materials, electrically conductive polymers.

According to the invention, “(semi) metals” are selected from the group consisting of metals, semimetals, and are preferably metals.

Metals are in particular selected from the group consisting of zinc, iron, copper, silver, gold, chromium, nickel, tin, indium.

Semimetals are in particular selected from the group consisting of silicon, germanium, gallium, arsenic, antimony, selenium, tellurium, polonium

The at least one conductivity additive L is more preferably a carbon material.

Carbon materials are selected in particular from the group consisting of carbon fibers, carbon nanotubes (carbon nanotubes “CNT”), graphite, graphene, carbon black, fullerene.

Electrically conductive polymers are in particular selected from the group consisting of polypyrroles, polyanilines, polyphenylenes, polypyrenes, polyazulenes, polynaphthenes, polycarbazoles, polyindoles, polyazepines, polyphenylene sulfides, polythiophenes, polyacetylenes, poly (3,4-ethylenedioxythiophene) polystyrene sulfonate (=PEDOT:PSS), polyazenes, Poly (p-phenylene vinylenes) are selected.

### 3.2.2. Preferred Amount of the Conductivity Additive L

The amount of the conductivity additive L comprised by the electrode material according to the invention is not further limited. However, it is preferred that in the electrode material according to the invention the ratio of the total weight of all conductivity additives L to the total weight of all organic redox active polymers P_{Redox} is in the range of 0.1 to 1000 wt. %, in particular in the range from 1 to 500 wt. %, preferably in the range from 10 to 100% wt. %, more preferably in the range of 15 to 80 wt. %, more preferably in the range of 20 to 60 wt. %, more preferably in the range from 25 to 50 wt. %, more preferably in the range of 30 to 50 wt. %.

### 3.3 Optional Ionic Liquid IL₁

The electrode material according to the invention optionally and preferably comprises at least one ionic liquid IL₁. The ionic liquid IL₁ has in particular a melting point <100° C. preferably <70° C., particularly preferably <50° C.

### 3.3.1 Preferred Ionic Liquid IL₁

The ionic liquid IL₁ is not restricted and described, for example, in WO 2004/016631 A1, WO 2006/134015 A1, US 2011/0247494 A1 or US 2008/0251759 A1.

In particular, the ionic liquid IL₁, which is comprised by the electrode material according to the invention, has the structure QA.

### 01.3.1.1 Preferred Cation Q+ of the IL

Therein, Q⁺ is preferably a cation selected from the group consisting of the following structures (Q1), (Q2), (Q3), (Q4), (Q5):

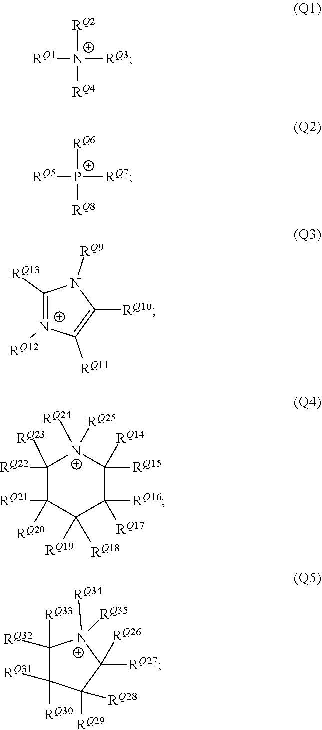

wherein R^{Q1}, R^{Q2}, R^{Q3}, R^{Q4}, R^{Q5}, R^{Q6}, R^{Q7}, R^{Q8} are each independently selected from the group consisting of alkyl group, haloalkyl group, cycloalkyl group.
wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R_{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group. (poly) ether group, haloalkyl group, cycloalkyl group.

More preferably. Q⁺ is a cation selected from the group consisting of the structures (Q1), (Q2), (Q3), (Q4), (Q5), wherein R^{Q1}, R^{Q2}, R^{Q3}, R^{Q4}, R^{Q5}, R^{Q6}, R^{Q7}, R^{Q8} are each independently selected from the group consisting of alkyl group with 6 to 40, more preferably 10 to 30 carbon atoms, cycloalkyl group with 6 to 40, more preferably 10 to 30 carbon atoms,
R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{q30}, R^{Q31}, R^{Q32}, R^{Q33}, R^{Q34}, R^{Q35} are each independently selected from the group consisting of hydrogen, alkyl group with 1 to 25, preferably 1 to 10, carbon atoms, (poly) ether group with 1 to 25, preferably 1 to 10, carbon atoms.

In the context of the invention, “(poly) ether group” means “polyether group or ether group”, preferably “polyether group”.

More preferably, Q⁺ is a cation selected from the group consisting of the structures (Q1), (Q3) wherein R^{Q1}, R^{Q2}, R^{Q3}, R^{Q4} are each independently selected from the group consisting of alkyl group with 6 to 30, preferably 10 to 25, carbon atoms,
and wherein R^{Q9}, R^{Q10}, R^{Q11}, R^{Q12}, R^{Q13} are each independently selected from the group consisting of hydrogen, alkyl group with 1 to 25, preferably 1 to 10 carbon atoms, and even more preferably R^{Q10}, R^{Q11}, R^{Q13} are each hydrogen and R^{Q9}, R^{Q12} are each independently an alkyl moiety with 1 to 6 carbon atoms.

More preferably, Q⁺ is a cation of the structure (Q3), wherein R^{Q10}, R^{Q11}, R^{Q13} are each hydrogen and R^{Q9} is selected from the group consisting of alkyl group with 1 to 25, preferably 1 to 10 carbon atoms, more preferably methyl, ethyl, n-propyl, iso-propyl, n-butyl, sec-butyl, tert-butyl, and R^{Q12} is selected from the group consisting of alkyl group with 1 to 25, preferably 1 to 10, carbon atoms preferably methyl, ethyl, n-propyl, iso-propyl, n-butyl, sec-butyl, tert-butyl.

More preferably, Q⁺ is a cation of the structure (Q3), wherein R^{Q10}, R^{Q11}, R^{Q13} are each hydrogen and R^{Q9} is selected from the group consisting of methyl, ethyl, n-butyl, preferably selected from the group consisting of ethyl, n-butyl, wherein R^{Q9} is most preferably ethyl, and R^{Q12} is selected from the group consisting of methyl, ethyl wherein R Q12 is most preferably methyl.

Particularly preferred as Q⁺ is the 1-ethyl-3-methylimidazolium cation.

### 3.3.1.2 Preferred Anion A⁻ of the IL

In the aforementioned formula Q⁺A⁻, A⁻ is an anion selected in particular from the group consisting of phosphate, phosphonate, alkyl phosphonate, monoalkyl phosphate, dialkyl phosphate, bis [trifluoromethanesulfonyl] imide, alkylsulfonate haloalkylsulfonate, alkyl sulfate, haloalkyl sulfate, bis [fluorosulfonyl] imide, halide, dicyanamide, hexafluorophosphate, sulfate, tetrafluoroborate, trifluoromethanesulfonate, perchlorate, hydrogen sulfate, haloalkylcarboxylate, alkyl carboxylate, formate bisoxalatoborate, tetrachloroaluminate, dihydrogen phosphate, monoalkylhydrogenphosphate, nitrate.

In the aforementioned formula Q⁺A⁻, A⁻ is more preferably selected from the group consisting of phosphate, phosphonate, alkyl phosphonate, monoalkyl phosphate, dialkyl phosphate, bis [trifluoromethanesulfonyl] imide, alkyl sulfonate, alkyl sulfate, bis [fluorosulfonyl] imide, halide, dicyanamide, hexafluorophosphate, sulfate, tetrafluoroborate, trifluoromethanesulfonate, perchlorate, hydrogen sulfate, alkyl carboxylate, formate, bisoxalatoborate, tetrachloroaluminate, dihydrogen phosphate monoalkylhydrogenphosphate, nitrate, where the alkyl groups are in alkyl phosphonate, monoalkyl phosphate, dialkyl phosphate, alkyl sulfonate, alkyl sulfate, alkyl carboxylate, monoalkylhydrogenphosphate in each case 1 to 10, preferably 1 to 6, more preferably 1 to 4 carbon atoms.

In the aforementioned formula Q⁺A⁻, A⁻ is more preferably selected from the group consisting of dialkyl phosphate, bis [trifluoromethanesulfonyl] imide, alkyl sulfonate, alkyl sulfate, bis [fluorosulfonyl] imide, chloride dicyanamide, hexafluorophosphate tetrafluoroborate, trifluoromethanesulfonate, perchlorate, acetate, proprionate, formate, tetrachloroaluminate, monoalkylhydrogenphosphate, nitrate, where the alkyl groups are in dialkyl phosphate, alkyl sulfonate monoalkylhydrogenphosphate in each case have 1 to 10, preferably 1 to 6, even more preferably 1 to 4 carbon atoms.

In the aforementioned formula Q⁺A⁻, A⁻ is even more preferably selected from the group consisting of diethyl phosphate, bis [trifluoromethanesulfonyl] imide, methyl sulfonate, methyl sulfate, bis [fluorosulfonyl] imide, chloride dicyanamide hexafluorophosphate, tetrafluoroborate, trifluoromethanesulfonate, perchlorate, acetate, proprionate, formate, tetrachloroaluminate, monoethylhydrogenphosphate, nitrate.

In the aforementioned formula Q⁺A⁻. A⁻ is even more preferably selected from the group consisting of methyl sulfonate, methyl sulfate, trifluoromethanesulfonate, bis [trifluoromethanesulfonyl] imide, diethylphosphate, dicyanamide, most preferably selected from the group consisting of trifluoromethanesulfonate, bis [trifluoromethanesulfonyl]imide, most preferably trifluoromethanesulfonate.

### 3.3.2 Mass of the IL_{L} Used

The mass of the ionic liquid IL₁ comprised by the electrode material according to the invention is not further restricted.

In the embodiments in which the electrode material according to the invention comprises at least one ionic liquid IL₁, however, it is preferred that in the electrode material according to the invention the ratio of the total weight of all ionic liquids IL₁ to the total weight of all organic redox active polymers P_{Redox} is in the range of 0. 1 to 1000 wt. %, in particular in the range from 1 to 500% wt. %, preferably in the range from 1 to 100 wt. %, more preferably in the range from 5 to 80% wt. %, more preferably in the range of 10 to 70 wt. %, more preferably in the range of 15 to 60 wt. %, more preferably in the range of 20 to 50 wt. %, more preferably in the range of 20 to 45 wt. %, more preferably in the range from 25 to 40% wt. %, more preferably in the range of 28 to 35 wt. %.

### 3.4 Binder B

The electrode material according to the invention comprises at least one binder B and is characterized in that
the binder B comprises at least one polymer P_{B1}, which comprises a repeating unit of the following structural formula (I):

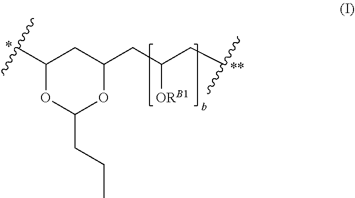

wherein R^{B1} is hydrogen or acetyl,
a is an integer ≥10, in particular an integer in the range from 10 to 1(0, preferably an integer in the range from 10 to 10³, more preferably an integer in the range from 10 to 10⁴, more preferably an integer in the range of 20 to 5000, more preferably an integer in the range of 50 to 2000, more preferably an integer in the range of 70 to 700,
is an integer 0, in particular an integer in the range from 0 to 5000, preferably an integer in the range from 0 to 1000, more preferably an integer in the range from 0 to 100, even more preferably an integer in the range from 0 to 70, even more preferably an integer in the range from 0 to 50, even more preferably an integer ranging from 0 to 30, even more preferably an integer ranging from 0 to 20, even more preferably an integer ranging from 0 to 4, more preferably an integer ranging from 0 to 2, most preferably 0 or 1,
and wherein the bond marked by “*” binds a repeating unit of the structural formula (I) to the bond marked by “**” of the adjacent repeating unit of the structural formula (I),
and the repeating units of the structural formula (I) comprised by the polymer P_{B1} are identical or different from each another.

It is self-evident that for the case wherein a repeating unit b≥2 applies, the individual moieties R^{B1} within this repeating unit can be the identical or different from each another, that is, within this repeating unit, either all hydrogen or all acetyl are or R^{B1} within this repeating unit is partially hydrogen and partially acetyl.

According to the invention, the polymer P_{B1} accordingly also comprises a polymer which comprises at least one unit of the following structural formula (V):

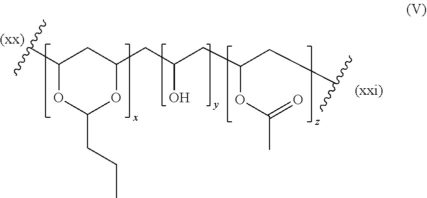

in which x is an integer ≥10, in particular an integer in the range from 10 to 10⁶, preferably an integer in the range from 10 to 10⁵, more preferably an integer in the range from 10 to 10⁴, more preferably an integer in the range of 20 to 5000, more preferably an integer in the range of 50 to 2000, more preferably an integer in the range of 70 to 700,
y, z independently of each other are an integer ≥0, in particular an integer in the range from 0 to 5000, preferably an integer in the range from 0 to 1000, more preferably an integer in the range from 0 to 100, more preferably an integer ranging from 0 to 70, more preferably an integer ranging from 0 to 50, more preferably an integer ranging from 0 to 30, even more preferably an integer ranging from 0 to 20, even more preferably an integer ranging from 0 to 4, even more preferably an integer ranging from 0 to 2, most preferably 0 or 1,
and wherein, when the polymer P_{B1} comprises a plurality of units of the structural formula (V), the units of the structural formula (V) are identical or different from each other and then further the bond marked by “(xx)” binds a repeating unit of the structural formula (V) each to the bond marked by “(xxi)” of the adjacent repeating unit.

“Acetyl” is a group of the following chemical formula:

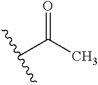 [SMILES: *C(C)=O]

In a preferred embodiment, the ratio of the total weight of all repeating units of the structural formula (Ib) comprised by polymer P_{B1} to the total weight of all repeating units of the structural formulae (Ia) and (Ib) comprised by polymer P_{B1} is >0, and lies in particular in the range from >0 to 90%, preferably in the range from 1 to 80%, more preferably in the range from 5 to 70%, more preferably in the range from 10 to 60%, still more preferably in the range from 15 to 50%, still more preferably in the range from 16 to 45%, still more preferably in the range from 20 to 40%, still more preferably in the range from 25 to 31%, still more preferably in the range from 27 to 30%, still more preferably in the range from 28 to 29%, wherein (In) and (Ib) each have the following structural formulae:

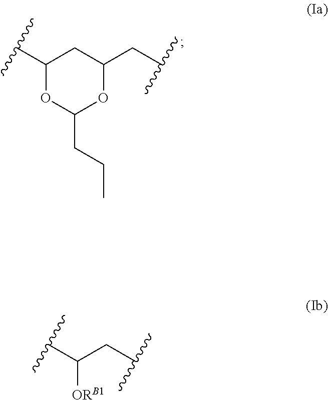

and wherein RBI is hydrogen or acetyl.

In this embodiment, it is preferred that in 0 to 66%, in particular in 1 to 57%, preferably in 2 to 50%, even more preferably in 3.7 to 44%, even more preferably in 3.7 to 35%, even more preferably in 3.7 to 27%, even more preferably in 3.7 to 25%, more preferably in 3.7 to 22%, even more preferably in 3.7 to 19%, even more preferably in 3.7 to 16.7%, even more preferably in 4.2 to 5.5%, even more preferably in 4.7 to 5. 5%, all repeating units of the structure (Ib) comprised by polymer P_{B1}, R^{B1}=acetyl, and in the remaining repeating units of the structure (Ib) comprised by polymer P_{B1}, R^{B1}=hydrogen.

The proportion of the repeating units of the structural formulae (Ia) and (Ib) and the proportion of repeating units of the structure (Ib) in which R_{B1} is acetyl or hydrogen, in a given polymer can be determined by a person skilled in the art with methods, such as NMR, IR or by a titration method (alkali ometry), as described in U.S. Pat. No. 6,743,859 B2, in particular NMR.

It is preferred that in the electrode material according to the invention the ratio of the total weight of all the binders B to the total weight of all organic redox active polymers P_{Redox} is in the range 0.001 to 100 wt. %, more preferably in the range 0.1 to 90% wt. %, even more preferably in the range from 3 to 70% wt. %, more preferably in the range from 5 to 50% wt. %, more preferably in the range of 8 to 20 wt. % and most preferably 13 to 17 wt. %0.

The polymer P_{B1} according to the invention can also have polyethylene units.

The preparation of PVB is known to the person skilled in the art and can be obtained by reacting polyvinyl alcohol (PVOH) with butanal. If the polymer PB, according to the invention is also to have polyethylene units, in the preparation instead of PVOH, ethylenevinyl alcohol copolymer (EVOH) (sold for example by Kuraray under the trademark ExCeval®) can be used.

In a further preferred embodiment, the at least one binder B comprises at least one further polymer P_{B2} different from the polymer P_{B1}, which comprises a′ repeating units of the following structural formula (I′):

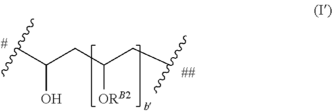

wherein R^{B2} is acetyl,
a′ is an integer ≥10, in particular an integer in the range from 10 to 10⁶, preferably an integer in the range from 20 to 20000, more preferably an integer in the range of 200 to 2000, more preferably an integer in the range of 70 to 400,
b′ is an integer ≥0, in particular an integer in the range from 0 to 5000, preferably an integer in the range from 0 to 1000, more preferably an integer in the range from 0 to 100, even more preferably an integer in the range from 0 to 70, more preferably an integer ranging from 0 to 50, more preferably an integer ranging from 0 to 30, more preferably an integer ranging from 0 to 20, even more preferably an integer ranging from 0 to 4, more preferably an integer in the range of 0 to 2, most preferably 0 or 1,
and wherein the bond marked by “#” binds a repeating unit of the structural formula (I′) to the bond marked by “##” of the adjacent repeating unit of the structural formula (I′),
and the repeating units of structural formula (I′) comprised by the polymer Pm are identical or different from each other.

In a further preferred embodiment of the electrode material according to the invention, the ratio of the total weight of all repeating units of the structural formula (Ib′) comprised by polymer Pm to the total weight of all repeating units of structural formulae (Ia′) and (Ib′) comprised by polymer Pm is >0, in particular in the range of >0 to 85%, preferably in the range of 1 to 75%, more preferably in the range of 5 to 65%, more preferably in the range of 10 to 55%, wherein (Ia′) and (Ib′) each have the following structural formulae:

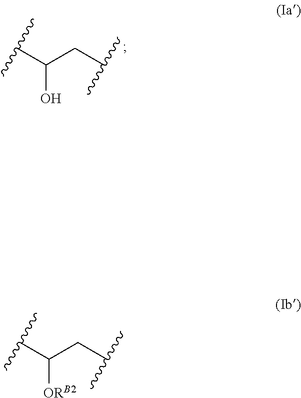

and wherein R^{B2} is acetyl.

In the embodiments, in which the binder B of the electrode material according to the invention comprises polymers P_{B1} and P_{B2}, it is particularly preferred that the ratio of the total weight of all polymers Pm comprised by binder B to the total weight of all polymers P_{B1} comprised by binder B is in the range 99:1 to 1:99, preferably in the range 9:1 to 1:9, more preferably in the range from 3:2 to 1:4, even more preferably in the range from 1:1 to 3:7.

In a preferred embodiment of the present invention, in the electrode material according to the invention the ratio of the total weight of all binder B to the total weight of all organic redox active polymers P_{Redox} is in the range 0.001 to 100 wt. %, more preferably in the range 0.1 to 90 wt. %, even more preferably in the range from 3 to 70 wt. %, even more preferably in the range from 5 to 50 wt. %, even more preferably 10 to 40 wt. %, even much more preferably in the range of 15 to 30 wt. %.

### 3.5 Solvent

The electrode material according to the invention can comprise at least one solvent which differs from the IL₁. In these cases, the electrode material according to the invention is typically present as an electrode slurry. The electrode slurry is in this case in particular a solution or a suspension and comprises the electrode material according to the invention. The electrode slurry can be used in particular as an ink in printing processes.

Particularly suitable solvents according to the invention preferably have a boiling point at atmospheric pressure of 50° C. to 250° C. preferably 55° C. to 150° C.

Particularly suitable solvents according to the invention are selected in particular from the group consisting of water, alcohols, ethers, ketones, esters, preferably selected from the group consisting of water, alcohols, ethers, ketones, esters, more preferably selected from the group consisting of water, alcohols.

Particularly suitable alcohols according to the invention are preferably selected from the group consisting of glycol, methanol, n-butanol, 2-ethylhexanol, iso-butanol, iso-propanol, n-pentanol, n-propanol, 2-methylbutanol, di-iso-butyl carbinol ethanol, and more preferably selected from the group consisting of glycol, methanol, iso-propanol, n-propanol, ethanol.

Particularly suitable esters according to the invention are preferably selected from the group consisting of n-butyl acetate, propylene glycol diacetate, n-amyl acetate, iso-butyl acetate, n-propyl acetate, n-butylproprionate, n-pentylproprionate, n-propylproprionate.

Particularly suitable ethers according to the invention are in particular glycol ethers which are preferably selected from the group consisting of propylene glycol methyl ether, dipropylene glycol methyl ether, tripropylene glycol methyl ether, propylene glycol methyl ether acetate dipropylene glycol n-propyl ether, dipropylene glycol n-propyl ether, propylene glycol n-butyl ether, dipropylene glycol n-butyl ether, propylene glycol pentyl ether, dipropylene glycol phenyl ether, propylene glycol diacetate dipropylene glycol n-butyl ether acetate, dipropylene glycol dimethyl ether, diethylene glycol methyl ether. Triethylene glycol methyl ether, diethylene glycol ethyl ether, Triethylene glycol ethyl ether, ethylene glycol propyl ether, ethylene glycol n-butyl ether, diethylene glycol n-butyl ether, triethylene glycol n-butyl ether, ethylene glycol n-butyl ether acetate, diethylene glycol n-butyl ether acetate, ethylene glycol hexyl ether diethylene glycol hexyl ether, ethylene glycol phenyl ether, diethylene glycol phenyl ether, α-phenyl-ω-hydroxy-poly (oxy-1, 2-ethanediyl), ethylene glycol phenyl ether.

Particularly suitable ketones according to the invention are preferably selected from the group consisting of acetone, methyl ethyl ketone, methyl iso-butyl ketone, butyl ketone.

In a further preferred embodiment of the present invention, the solvent is at least one selected from the group consisting of methyl ethyl ketone, ethanol, n-propanol, 2-butanol, water, iso-propanol, for example a mixture of water and iso-propanol in a weight ratio of 1:4.

The concentration of the redox active material, in particular of the organic redox active polymer P_{Redox} according to the invention, for storing electrical energy in the aforementioned electrode slurry is preferably between 1 and 1000 mg/ml, preferably 30 to 300 mg/ml, more preferably 50 to 200 mg/ml, particularly preferably 60 to 180 mg/ml.

### 3.6 Electrode

The present invention also relates to an electrode (other word “electrode element”) comprising the electrode material according to the invention and a substrate.

The substrate of the electrode element comprises in particular at least one selected from the group consisting of conductive materials, preferably metals, carbon materials, oxide substances, conductive polymers. These conductive materials are preferably applied to non-conductive materials, in particular to non-conductive polymers or cellulose compounds.

Preferred conductive polymers are selected from the group consisting of polypyrroles, polyanilines, polyphenylenes, polypyrenes, polyazulenes, polynaphthenes, polycarbazoles, polyindoles, polyazepines, polyphenylene sulfides, polythiophenes, polyacetylenes, polythiophenes, polythiophenes, polyacetylenes, polythiophenes, poly (3,4-ethylenedioxythiophene) polystyrene sulfonate (=PEDOT:PSS), polyazenes, poly (p-phenylene vinylenes).

Preferred non-conductive polymers are selected from the group consisting of polyethylene, polyethylene terephthalate (=PET), polyurethane, polyester, polypropylene, polyimides, epoxy resins.

Preferred cellulose compounds according to the invention are cellulose, cardboard, paper. If these are used, they preferably carry a conductive layer. Accordingly, the substrate according to the invention is preferably at least one cellulose compound which has a layer comprising at least one selected from silver, silver/carbon, PEDOT:PSS.

Preferred substrates comprising non-conductive polymers on which conductive materials are applied are selected from
metallized polypropylene,
metallized PET,
polyethylene terephthalate (PET) coated with an oxide layer (preferably ITO, AZO),
polypropylene coated with an oxide layer (preferably ITO, AZO).

Metals which are preferred according to the invention as a substrate of the electrode element are selected from platinum, gold, iron, copper, aluminum, zinc, silver or a combination of these metals. These metals may also be present as mixtures with carbon, such as silver/carbon arresters.

Preferred carbon materials according to the invention as the substrate of the electrode element are selected from glass carbon, graphite foil, graphene, carbon film.

Preferred oxide substances according to the invention as the substrate of the electrode element are selected, for example, from the group consisting of indium tin oxide (ITO), indium zinc oxide (IZO), aluminum zinc oxide (AZO) tin oxide (FTO) or aluminum tin oxide (ATO), zinc oxide (ZO).

The surface layer of the electrode element comprises at least the electrode material according to the invention according to the first aspect of the invention as redox active material for the charge storage.

The electrode material according to the invention according to the first aspect of the invention is applied to the substrate of the electrode element in particular as an electrode slurry.

The electrode material according to the invention according to the first aspect of the invention is applied in particular as an electrode slurry to the substrate of the electrode element. The electrode slurry in this case is in particular a solution or suspension and comprises the electrode material according to the invention and a solvent as described in section 3.5.

In the embodiment in which the electrode material according to the invention is formed as an at least partial surface coating of electrode elements for electrical charge storage devices, in particular secondary batteries, an electrode element has at least partially a layer on a substrate surface. The layer comprises in particular the electrode material according to the invention.

The application of the electrode material according to the invention according to the first aspect of the invention (other expression for composition: “composite”) on the substrate is possible with the aid of methods known to the person skilled in the art. In particular, according to the first aspect of the invention, the electrode material according to the invention is applied as an electrode slurry on the substrate by means of knife coating, slot nozzle coating, rolling, spraying, screen printing, gravure printing, pad printing, flexographic printing, stencil printing.

### 3.7 Charge Storage Device

The present invention also relates to an electrical charge storage device, in particular a secondary battery, comprising at least one electrode according to the invention.

In general, redox active electrode materials for storing electrical energy are materials which store and release electrical charge, for example, by recording or discharging electrons. The electrode material according to the invention can accordingly be incorporated, for example, as an active electrode material in an electrical charge storage device. Such electrical charge storage devices for storing electrical energy are selected in particular from the group consisting of primary batteries, secondary batteries (also called “accumulators”), redox flow batteries, supercapacitors.

The electrical charge storage device is preferably a primary or secondary battery, more preferably a secondary battery. In a preferred embodiment, the charge storage device according to the invention, preferably the battery, comprises at least one electrode according to the invention, at least one electrolyte and optionally a separator. More preferably, the charge storage device according to the invention, preferably the battery, comprises at least two electrodes, at least one electrolyte according to the invention, at least one electrolyte and optionally a separator according to the invention.

The main task of the electrolyte is to ensure the ion conductivity necessary for charge equalization. The electrolyte of the preferably secondary battery can contain both a liquid and an oligomeric or polymeric compound High ionic conductivity (“gel electrolyte” or “solid state electrolyte”. “solid electrolyte”), as described, for example, in WO 2020/126200 A1. Preferably, however, it is an oligomeric or polymeric compound.

If the electrolyte is liquid, it is composed, in particular, of one or more solvents and one or more conducting salts. In these cases, the electrolyte may comprise at least one ionic liquid.

The solvent of the electrolytes preferably comprises, independently of one another, one or more solvents having a high boiling point and high ionic conductivity, but low viscosity, such as, for example, acetonitrile, dimethyl sulfoxide ethylene carbonate, propylene carbonate, dimethyl carbonate, diethyl carbonate, methyl ethyl carbonate, y-butyrolactone, tetrahydrofuran, dioxolane, 1, 2-dimethoxyethane, 1, 2-diethoxyethane, diglyme, triglyme, tetraglyme, ethyl acetate, 1, 3-dioxolane, glycerol, polyglycerol, ethylene glycol or water.

The conductive salt of the electrolyte consists of a cation of the formula M^{e+} and an anion or formula An^{f-} of the formula (M^{e+})ₐ(An^{f-})_{b} where e and f are integers depending on the charge of M and An, and a and b are integers representing the molecular composition of the conductive salt.

As a cation of the above-mentioned conductive salt, positively charged ions, preferably metals of the first and second main groups, such as, for example, lithium, sodium, potassium or magnesium, but also other metals of the secondary groups, such as zinc, are used as well as organic cations, such as, for example, quaternary ammonium compounds such as tetraalkylammonium compounds.

As anions of said conductive salt are preferred inorganic anions, such as hexafluorophosphate, tetrafluoroborate, triflate, hexafluoroarsenate, hexafluoroantimonate, tetrafluoroaluminate, tetrafluoroborate, perchlorate, bis (oxolato) borate tetrachloroaluminate, tetrachlorogallate, but also organic anions, such as, for example, N(CF₃SO₂)₂⁻, CF₃SO₃⁻, alcoholates, such as, for example, tert-butanolate or iso-propyl alcoholate, but also halides, such as fluoride, chloride, bromide and iodide, are also used.

If ionic liquids are used, these can be used both as solvents of the electrolyte, as a conductive salt, but also as a complete electrolyte. In a preferred embodiment of the charge storage unit according to the invention, said charge storage unit comprises an ionic liquid IL₂ as an electrolyte. IL₂ preferably has the aforementioned structure Q⁺A⁻, where Q⁺ is, in particular, as in section 3.3.1.1 and A as in section 3.3.1.2. Even more preferably, the charge storage device IL₂ according to the invention is the same ionic liquid as is present as IL₁ in at least one electrode of the charge storage device according to the invention.

The separator is a porous layer which is ion-permeable and allows charge equalization. The object of the separator is to provide a separator to separate the positive electrode from the negative electrode and to allow charge equalization by permeation of ions. A porous material (eg, a porous material, for example, is used as a separator for the charge storage device, preferably the secondary battery) Nonwoven), preferably a membrane consisting of a polymeric compound, such as, for example, polyolefin, polyamide, or polyester. Furthermore, separators made of porous ceramic materials, glass microfiber can be used.

The separator and electrolyte may also be present in one, such as, for example, in the case of solid electrolytes, described in WO 2020/126200 A1.

In a further preferred embodiment of the charge storage device according to the invention, said charge storage device comprises at least two electrodes, wherein at least one of the electrodes comprises at least one electrode material according to the invention. In particular, the electrode material according to the invention comprises at least one organic redox active polymer of the aforementioned structural formula (II), in which in particular R^{X} is selected from the group consisting of the structural formulae (II-A), (II-B), (II-C), (II-D), (II-E), (II-F), (II-A), (II-B), (II-D), (II-E), (II-F), preferably (II-D), (II-E), (II-F), more preferably (II-D).

More preferably, at least one other of the electrode in this charge storage device comprises a polyimide according to the invention, which is preferably selected from the aforementioned structural formulae (III-A), (III-B), (III-C), (III-D) [preferably (III-C) and (III-D), more preferably (III-D).

### 3.8 Use of the Electrode Material According to the Invention

In a further aspect, the present invention relates to the use of the electrode material according to the invention as an ink in printing processes, in particular with doctor blades, slot nozzle coating, rolling, spraying, screen printing, gravure printing, pad printing flexographic printing, stencil printing, preferably gravure printing.

### EXAMPLES

### 4.1 General

### 4.1.1. Chemicals Used

Mowital® B 30 T from Kuraray was used as polyvinyl butyral (“PVB”; CAS number: 63148-65-2). This has a chemical structure corresponding to the aforementioned structural formula (I), in which a is in the range 40 to 600, b is in the range 0 to 100, wherein the ratio of the total weight of all the comprised repeating units of the structural formula (Ib) to the total weight of all the comprised repeating units of the structural formulae (Ia) and (Ib) is in the range of 25 to 31%, and wherein 3.7 to 16.7% of all of the groups marked by R^{B1} in the structure (I) are acetyl, the remaining groups marked by R^{B1} in the structure (I) are hydrogen.

POVAL™ L-8 (“PVOH”: CAS number: 9002-89-5) from Kuraray (saponification degree 69.5 to 72.5 mol %) was used as partially saponified polyvinyl alcohol.

Product 09963 (“HPMC”; CAS number: 9004-65-3) from Sigma-Aldrich was used as hydroxypropyl methylcellulose

Cellosize® QP-40′ (“HEC”: CAS number: 9004-62-0) from Union Carbide (product 54290 from Sigma Aldrich) was used as hydroxyethyl cellulose

MAC500 LC (“NaCMC”: CAS number: 9004-32-4), from Nippon Paper was used as carboxymethyl cellulose sodium salt.

1-ethyl-3-methylimidazolium triflate (“EMIMOTf”) from Solvolonic was used as ionic liquid.

Carbon black (“Super P” from Timcal) was used as conductive additive.

P84 was obtained from Evonik Industries. The polyimide (=“PT”) had the following structure, wherein the moiety R in the repeating units is independently selected from 4,4′-methylenebis (phenylene) moiety, 2,4-toluene unit, 2,6-toluene unit:

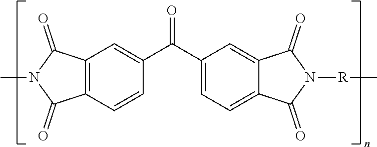

The PTMA polymer was synthesized according to WO 2018/046387 A1, wherein triethylene glycol dimethacrylate was added for the crosslinking in the synthesis. PTMA had the following structure:

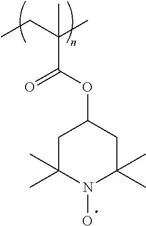

### 4.1.2. Methods

### 4.1.2.1 Viscosity Measurements

The viscosities mentioned in the present description and the examples refer to dynamic viscosity 11 at 25° C. The viscosity was measured with a Malvem Kinexus rotary rheometer with plate-plate geometry. The diameter of the plates amounted to 40 mm, the distance between the plates amounted to heranziehen 1 mm. The viscosity was measured at increasing shear rates between 0.1 and 500 s⁻, and the viscosity at 1 s⁻¹ accounted for the characteristic value.

### 4.1.2.2 Solids Content

The solids contents mentioned in the present description and the examples refer to the ratio of the total mass of the electrode material (active polymer, conductive additive, binder and ionic liquid) to the total mass of electrode material and propanol/water solvent mixture.

Indicated crosses “++” to “+++++” show how well the respective electrode material is suitable as a gravure ink, based on the solids content and the viscosity.

### 4.2 Inventive Example E1: Production of an Anode with PVB as Binder

2.2 g of polyvinyl butyral (“PVB”) was agitated at 80° C. within one hour in 76.3 g of a solvent consisting of 2-propanol with 20 wt. % of water. 4.4 g of EMIMOTf and 4.4 g of Super P were added and the resulting mixture was stirred using a stirrer dissolver for 15 minutes at 2000 rpm. Then, 15.4 g of polyimide “P84 type 70” as anode active polymer was added stepwise while agitating within 10 min and agitated for another 35 min at 2000 rpm.

The resulting dispersion was treated three times, five minutes each time with time interval of ten minutes at 22000 rpm with an IKA Ultra Turrax®. The described dispersion had a solids content of 26.4 wt. % and showed structurally viscous behavior with the viscosity of ˜251 mPa·s at a shear rate of 1/s. This makes it very suitable especially for gravure printing.

The dispersion was applied to an aluminum foil by box squeegee with 200 μm gap and then dried at room temperature overnight, then at 120° C. for two hours. The resulting anode layer had a coverage of 27 g/m².

### 4.3 Inventive Example E2: Production of a Cathode with PVB as Binder

1.4 g of polyvinyl butyral (“PVB”) was agitated at 80° C. within one hour in 83.2 g of a solvent consisting of 2-propanol with 25 wt. % of water. 2.8 g of EMIMOTf and 4.2 g of Super P were added and the resulting mixture was stirred using a stirrer dissolver for 15 minutes at 2000 rpm.

Then, 8.4 g of PTMA active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 16.8 wt. % and showed structurally viscous behavior with the viscosity of ˜427 mPa s at a shear rate of 1/s. This makes it very suitable especially for gravure printing.

The dispersion was applied to an aluminum foil by box squeegee with 200 μm gap and then dried at room temperature overnight, then at 120° C. for two hours. The resulting cathode laver had a coverage of 16 g/m².

### 4.4 Inventive Example E3: Production of an Anode with PVB/PVOH as Binder

A mixture of 1.2 g PVB and 1.2 g partially saponified PVOH was agitated at 80° C. within one hour in 71.2 g of a solvent consisting of 2-propanol with 20 wt. % of water. 4.8 g of EMIMOTf and 4.8 g of Super P were added and the resulting mixture was stirred using a stirrer dissolver for 15 minutes at 2000 rpm. Then, 16.8 g of polyimide “P84 type 70” as anode active polymer was added stepwise while agitating within 10 min and agitated for another 35 min at 2000 rpm.

The resulting dispersion was treated three times, five minutes each time with time interval of ten minutes at 22000 rpm with an IKA Ultra Turrax®. The described dispersion had a solids content of 28.8 wt. % and showed structurally viscous behavior with the viscosity of ˜378 mPa·s at a shear rate of 1/s. This makes it very suitable especially for gravure printing.

The dispersion was applied to an aluminum foil by box squeegee with 200 μm gap and then dried at room temperature overnight, then at 120° C. for two hours. The resulting anode layer had a coverage of 28 g/m².

### 4.5 Inventive Example E4: Production of a Cathode with PVB/PVOH as Binder

A mixture of 0.98 g PVB and 0.42 g partially saponified PVOH was agitated at 80° C. within one hour in 83.2 g of a solvent consisting of 2-propanol with 20 wt. % of water. 2.8 g of EMIMOTf and 4.2 g of Super P were added and the resulting mixture was stirred using a stirrer dissolver for 30 minutes at 2000 rpm.

Then, 8.4 g of PTMA active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 16.8 wt. % and showed structurally viscous behavior with the viscosity of ˜553 mPa s at a shear rate of 1/s. This makes it very suitable especially for gravure printing.

The dispersion was applied to an aluminum foil by box squeegee with 200 μm gap and then dried at room temperature overnight, then at 120° C. for two hours. The resulting cathode layer had a coverage of 21 g/m².

### 4.6 Comparative Example V5. Attempt of Production of an Anode with NaCMC as Binder

1.27 g of NaCMC was agitated at 80° C. within one hour in 84.76 g of a solvent consisting of 2-propanol with 20 wt. % of water. 2.54 g of EMIMOTf and 2.54 g of Super P were added and the resulting mixture was stirred using a stirrer dissolver for 15 minutes at 2000 rpm. Then, 8.89 g of polyimide “P84 type 70” as anode active polymer was added stepwise while agitating within 10 min and agitated for another 35 min at 2000 rpm.

The resulting dispersion was treated three times, five minutes each time with time interval of ten minutes at 22000 rpm with an IKA Ultra Turrax®. The described dispersion had a solids content of 15.2 wt. %. It showed a viscosity of ˜4200 mPa·s at a shear rate of 1/s. This makes it unsuitable for gravure printing.

The dispersion was applied to an aluminum foil by box squeegee with 200 μm gap and then dried at room temperature overnight, then at 120° C. for two hours. The resulting anode layer had a coverage of 20 g/m². However, it was inhomogeneous and did not adhere, so that the resulting layer was unusable as an electrode.

### 4.7 Comparative Example V6: Production of an Anode with HEC as Binder

2 g of HEC was agitated at 80° C. within one hour in 76 g of a solvent consisting of 2-propanol with 20 wt. % of water. 4 g of EMIMOTf and 4 g of Super P were added and the resulting mixture was stirred using a stirrer dissolver for 15 minutes at 2000 rpm.

Then, 14 g of polyimide “P84 type 70” as anode active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 24 wt. % and showed structurally viscous behavior with the viscosity of ˜4800 mPa·s at a shear rate of 1/s. This makes it unsuitable for gravure printing.

The dispersion was applied to an aluminum foil by box squeegee with 200 μm gap and then dried at room temperature overnight, then at 120° C. for two hours. The resulting anode layer had a coverage of 31 g/m².

### 4.8 Comparative Example V7: Production of a Cathode with HEC as Binder

1.2 g of HEC was agitated at 80° C. within one hour in 85.6 g of a solvent consisting of 2-propanol with 25 wt. % of water. 2.4 g of EMIMOTf and 3.6 g of Super P were added and the resulting mixture was stirred using a stirrer dissolver for 15 minutes at 2000 rpm.

Then, 7.2 g of PTMA active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 14.4 wt. %. It showed a viscosity of ˜1060 mPa·s at a shear rate of 1/s. This makes it unsuitable for gravure printing.

The dispersion was applied to an aluminum foil by box squeegee with 200 μm gap and then dried at room temperature overnight, then at 120° C. for two hours. The resulting cathode layer had a coverage of 13 g/m².

### 4.9 Comparative Example V8: Production of an Anode with HPMC as Binder

2 g of HPMC was agitated at 80° C. within one hour in 76 g of a solvent consisting of 2-propanol with 20 wt. % of water. 4 g of EMIMOTf and 4 g of Super P were added and the resulting mixture was stirred using a stirrer dissolver for 15 minutes at 2000 rpm. Then, 14 g of polyimide “P84 type 70” as anode active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 24 wt. %. It showed a viscosity of ˜668 mPa s at a shear rate of 1/s. This makes it especially suitable for gravure printing.

The dispersion was applied to an aluminum foil by box squeegee with 200 μm gap and then dried at room temperature overnight, then at 120° C. for two hours. The resulting anode layer had a coverage of 30 g/m².

### Comparative Example V9: Production of a Cathode with HPMC as Binder

1.4 g of HPMC was agitated at 80° C. within one hour in 84.76 g of a solvent consisting of 2-propanol with 25 wt. % of water. 2.8 g of EMIMOTf and 4.2 g of Super P were added and the resulting mixture was stirred using a stirrer dissolver for 15 minutes at 2000 rpm.

Then, 8.4 g of PTMA active polymer was added stepwise while agitating within 60 min and agitated for another 30 min at 2000 rpm.

The resulting dispersion was treated three times, five minutes each time with time interval of ten minutes at 22000 rpm with an IKA Ultra Turrax®. The described dispersion had a solids content of 14.4 wt. %. It showed a viscosity of ˜463 mPa·s at a shear rate of 1/s. This makes it especially suitable for gravure printing.

The dispersion was applied to an aluminum foil by box squeegee with 200 μm gap and then dried at room temperature overnight, then at 120° C. for two hours. The resulting cathode layer had a coverage of 14 g/m².

### 4.11 Construction of the Full Cells and Measurement of Capacitance

From the coated layer resulting from examples E1 to E4 and V6 to V9, circles were punched and button cells (2032 cases) were constructed from them with EMIMOTf electrolyte and with a separator (glass microfiber, Whatman GF/A). The weight ratios of the compositions (active polymer: conducting additive: binder: IL EMIMOTf) were kept constant at 7:2:1:2 for anodes and 6:3:1:2 for cathodes.

The following anodes and cathodes were combined:

### 4.11.1 Comparative Full Cells

Full cell consisting of HPMC-based anode of the comparative example V8 and HPMC-based cathode of the comparative example V9 (symbolized by “▴” when charged, symbolized by “Δ” when discharged).

Full cell consisting of HEC-based anode of the comparative example V6 and HEC-based cathode of the comparative example V7 (symbolized by “●” when charged, symbolized by “◯” when discharged).

### 4.11.2 Full Cells According to the Invention

Full cell of PVB-based anode of the inventive example E1 and PVB-based cathode of the inventive example E2 (symbolized by “▪” when charged, symbolized by “□” when discharged).

Full cell of PVB/PVOH-based anode of the inventive example E3 and PVB-based cathode of the inventive example E2 (symbolized by “♦” when charged, symbolized by “⋄” when discharged).

Full cell of PVB/PVOH-based anode of the inventive example E3 and PVB/PVOH-based cathode of the inventive example E4 (symbolized by “+” when charged, symbolized by “x” when discharged).

### 4.11.3 Measurement of the Capacity of the Full Cells

The capacity of the cells described in points 4.11.1 and 4.11.2 were measured as follows. Each full cell was subjected to 60 charge and discharge cycles. The first 20 and the last 20 cycles were performed with a charge rate “C” of 0.2 C. cycles 21 to 40 with a charge rate of 1 C. 1 C means full charge in one hour. 0.2 C means full charge in 5 hours.

The x-axis of the FIGURE indicates the respective charge cycle, the y-axis the capacity in mAh g-1. The results are summarized together with the characteristics of the respective example in the table below.

The charge and discharge capacities were measured on a Maccor Battery Cycler. The respective currents were calculated according to the active masses of the limiting electrode.

Galvanostatic (GS) means cycled up to a termination voltage with constant current. Galvanostatic/potentiostatic (GSPS) means that the cycle was still followed by a charge/discharge process at the termination voltage. Cycle 1-10 0.2 C (GS), 11-20 0.2 C (GSPS), 21-40 1 C (GS), 41-60 (GSPS).

### 4.12 Results

By comparing the charge and discharge capacities, it can be seen that by incorporating the electrodes with the binders of the invention PVB, optionally mixed with PVOH, full cells result, which have a higher capacity compared to the full cells with cellulose based binders (HEC, HMPC), insofar as these provide electrode-capable layers at all (which is not the case with NaCMC).

| | Example | | | | | | | | |
|---|---|---|---|---|---|---|---|---|---|
| | | | | | V5 Anode | V6 Anode | V7 Cathode | V8 Anode | V9 Cathode |
| | E1 Anode | E2 Cathode | E3 Anode | E4 Cathode | (Compar- | (Compar- | (Compar- | (Compar- | (Compar- |
| | (Iventive) | (Inventive) | (Inventive) | (Inventive) | ative) | ative) | ative) | ative) | ative) |
| Bindertyp | PVB | PVB | PVB:PVOH = | PVB:PVOH = | NaCMC | HEC | HEC | HPMC | HPMC |
| | | | 1:1 | 7:3 | | | | | |
| Binder [g] | 2.2 | 1.4 | 1.2 + 1.2 | 0.98 + 0.42 | 1.27 | 2 | 1.2 | 2 | 1.4 |
| Solvent mixture | 80:20 | 75:25 | 80:20 | 80:20 | 80:20 | 80:20 | 75:25 | 80:20 | 75:25 |
| (weight ratio of 2- | | | | | | | | | |
| propanol to H₂O) | | | | | | | | | |
| Solvent mixture [g] | 73.6 | 83.2 | 71.2 | 83.2 | 84.76 | 76 | 85.6 | 76 | 83.2 |
| Active polymer | P84 Typ | PTMA | P84 Typ | PTMA | P84 Typ | P84 Typ | PTMA | P84 Typ | PTMA |
| | 70 PI | | 70 PI | | 70 PI | 70 PI | | 70 PI | |
| Active polymer [g] | 15.4 | 8.4 | 16.8 | 8.4 | 8.89 | 14 | 7.2 | 14 | 8.4 |
| Conductive additive | 4.4 | 4.2 | 4.8 | 4.2 | 2.54 | 4 | 3.6 | 4 | 4.2 |
| Super P [g] | | | | | | | | | |
| EMIMOTf [g] | 4.4 | 2.8 | 4.8 | 2.8 | 2.54 | 4 | 2.4 | 4 | 2.8 |
| Total mass [g] | 100 | 100 | 100 | 100 | 100 | 100 | 100 | 100 | 100 |
| Active polymer:Con- | 7:2:1:2 | 6:3:1:2 | 7:2:1:2 | 6:3:1:2 | 7:2:1:2 | 7:2:1:2 | 6:3:1:2 | 7:2:1:2 | 6:3:1:2 |
| ductive addi- | | | | | | | | | |
| tive:Binder:EMIMOTf | | | | | | | | | |
| Solid content | 26.4 | 16.8 | 28.8 | 16.8 | 15.2 | 24 | 14.4 | 24 | 16.8 |
| (including | | | | | | | | | |
| EMIMOTf) [wt. %] | | | | | | | | | |
| Viscosity @1/s | 251 | 427 | 378 | 553 | 4200 | 4800 | 1060 | 668 | 463 |
| [mPa*s] | | | | | | | | | |
| Coating weight | 27 | 16 | 28 | 21 | 20 | 31 | 13 | 30 | 16 |
| [g/m2] [g/m²] | | | | | | | | | |
| Suitable for gravure | Yes | Yes | Yes | Yes | No | No | No | Yes | Yes |
| printing? | | | | | | | | | |
| Solid | +++++ | +++ | +++++ | +++ | − | ++ | ++ | ++++ | +++ |
| content/Viscosity | | | | | | | | | |
| Capacity after 20 | 10 | | 8 | | | 4 | | 0.8 | |
| cycles | | | | | | | | | |
| [mAh/g(PTMA)] | | | | | | | | | |
| Capacity after 20 | | 12 | | | | | | | |
| cycles | | | | | | | | | |
| [mAh/g(PTMA)] | | | | | | | | | |

1. An electrode material comprising:
(i) at least one organic redox active polymer P_{Redox},
(ii) at least one conductivity additive L,
(iii) at least one binder B,
(iv) optionally at least one ionic liquid IL₁,
whereby
the binder B comprises at least one polymer P_{B1}, which comprises a repeating unit of the following structural formula (I): 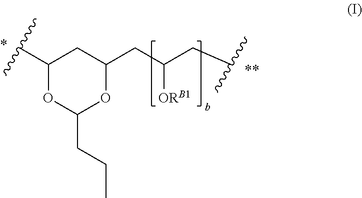
wherein R^{B1} is one of hydrogen or acetyl,
a is an integer ≥10,
b is an integer ≥0,
and wherein the bond marked by “*” binds a repeating unit of the structural formula (I) to the bond marked by “**” of the adjacent repeating unit of the structural formula (I).

2. The electrode material according to claim 1, wherein the ratio of the total weight of all repeating units of the structural formula (Ib) comprised by polymer P_{B1} to the total weight of all repeating units of the structural formulae (Ia) and (Ib) comprised by polymer P_{B1} is >0, wherein (Ia) and (Ib) have the following structural formulae: 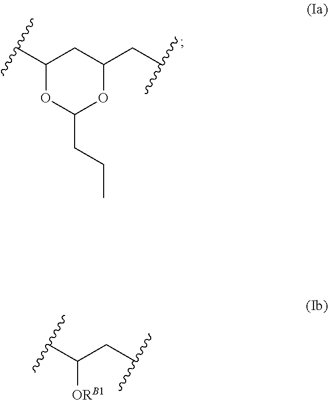
and wherein R^{B1} is one of hydrogen or acetyl.

3. The electrode material according to claim 2, wherein in 0 to 66% of all of the repeating units of the structure (Ib) comprised by polymer P_{B1}, R^{B1}=acetyl, and in the remaining ones of the repeating units of the structure (Ib) comprised by polymer P_{B1}, R^{B1}=hydrogen.

4. The electrode material according to claim 1, wherein the at least one binder B comprises at least one further polymer P_{B2} different from polymer P_{B1}, which comprises a′ repeating units of the following structural formula (I′): 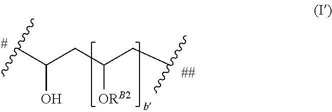
wherein R^{B2} is acetyl,
a′ is an integer ≥10,
b′ is an integer ≥0,
and wherein the bond marked by “#” binds a repeating unit of the structural formula (I′) to the bond marked by “##” of the adjacent repeating unit of the structural formula (I′).

5. The electrode material according to claim 4, wherein the ratio of the total weight of all of the repeating units of the structural formula (Ib′) comprised by polymer P_{B2} to the total weight of all repeating units of structural formulae (Ia′) and (Ib′) comprised by polymer P_{B2} is >0, wherein (Ia′) and (Ib′) each have the following structural formulae: 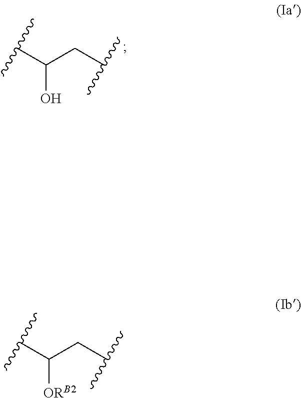
and wherein R^{B2} is acetyl.

6. The electrode material according to claim 4, wherein the ratio of the total weight of all polymers P^{B2} comprised by binder B to the total weight of all polymers P^{B1} comprised by binder B is in the range 99:1 to 1:99.

7. The electrode material according to claim 1, wherein the ratio of the total weight of all binders B comprised by the electrode material to the total weight of all organic redox active polymers P_{Redox} comprised by the electrode material is in the range of 0.001 to 100% by weight.

8. The electrode material according to claim 1, wherein the at least one organic redox active polymer P_{Redox} is selected from the group consisting of polyimides and organic redox active polymers comprising m repeating units of the following structural formula (II): 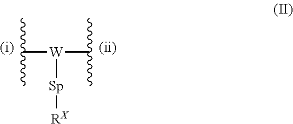
wherein m is an integer ≥4,
W is an organic unit,
Sp is an organic spacer,
and R^{X} is an organic redox active group,
and wherein the bond marked by “(i)” binds a repeating unit of the structural formula (II) to the bond marked by (ii)” of the adjacent repeating unit of the structural formula (II).

9. The electrode material according to claim 8, wherein R^{X} is selected from the group consisting of the following structural formulae (II-A), (II-B), (II-C), (II-D), (II-E), (II-F): 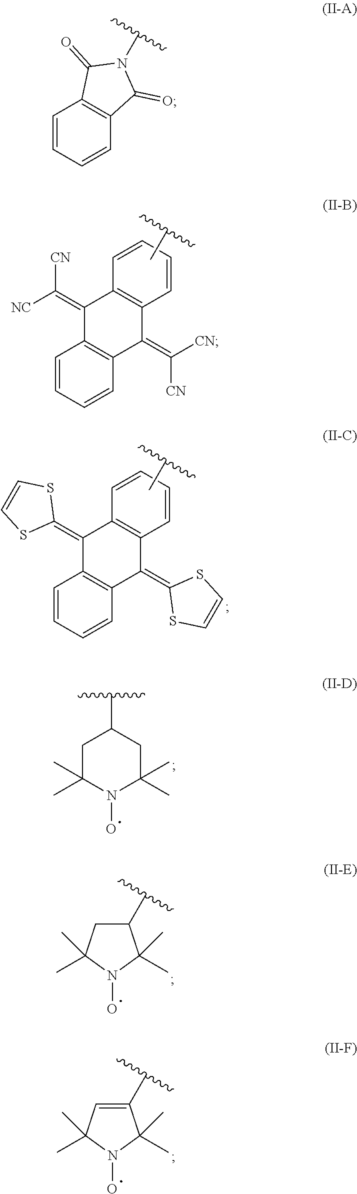
wherein, in the structural formulae (II-A), (II-B) and (II-C), at least one aromatic carbon atom can be substituted with a group selected from alkyl group, halogen group, alkoxy group, hydroxy group.

10. The electrode material according to claim 8, wherein the organic unit W in the structural formula (II) is selected from the group consisting of the structural formulae (W1), (W2), (W3): 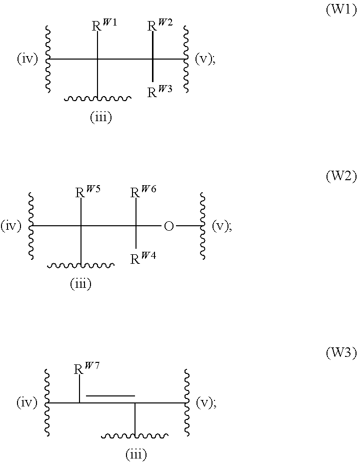
wherein, in the organic redox active polymer P_{Redox} each of the bond marked by “(iv)” binds a structural formula (W1), (W2), (W3) to the bond marked by “(v)” of the adjacent structural formula (W1), (W2) or (W3),
and wherein each bond marked by “(iii)” marks the bond to Sp,
and wherein R_{W1}, R^{W2}, R^{W3}, R^{W4}, R^{W5}, R^{W6}, R^{W7} are each independently selected from the group consisting of hydrogen, alkyl group, haloalkyl group, —COOR^{W8}R^{W8}=H or alkyl,
and wherein Sp, in the structural formula (II), is selected from the group consisting of direct bond, (Sp1), (Sp2): 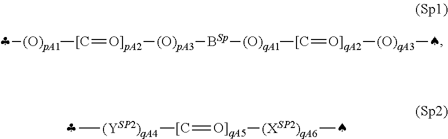
wherein pA1, pA2, pA3 are each 0 or 1, wherein the case “pA2=0, pA1=pA3=1” is excluded,
wherein qA1, qA2, qA3 are each 0 or 1, wherein the case “qA2=0, qA1=qA3=1” is excluded,
wherein qA4, qA5, qA6 are each 0 or 1, wherein at least one of qA4, qA5, qA6=1 and wherein the case “qA5=0, qA4=qA6=1” is excluded,
wherein X^{SP2}, Y^{SP2} are each independently NH or O, preferably both are O,
wherein B^{Sp} is selected from the group consisting of
divalent (hetero)aromatic moiety,
divalent moiety, optionally with at least one group selected from nitro group, —NH₂, —CN, —SH, —OH, halogen-substituted, and optionally with at least one group selected from ether, thioether, aminoether, carbonyl group, carboxylic acid ester, carboxylic acid amide group, sulfonic acid ester, phosphoric acid ester having an aliphatic moiety,
and wherein, in the cases in which Sp binds to an atom of the moiety R^{X} different from carbon, for the structure (Sp1), the additional condition “qA3=0, qA2=1, qA1=1 or qA3=qA2=qA1=0 or qA3=0, qA2=1, qA1=0” applies, and for the structure (Sp2) the additional condition “qA6=0, qA5=1, qA4=1 or qA6=0, qA5=1, qA4=0” applies,
and wherein “ [symbol] ” marks the bond pointing to R^{X},
and wherein “ [symbol] ” marks the bond pointing to W.

11. The electrode material according to claim 8, wherein the organic redox active polymer P_{Redox} is a polyimide comprising n repeating units selected from the following structural formulae (III-A), (III-B), (III-C), (III-D): 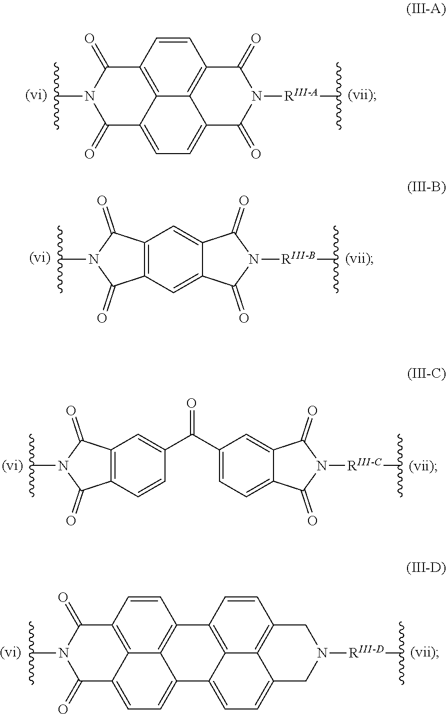
wherein R^{III-A}, R^{III-B}, R^{III-C}, R^{III-D} are each independently selected from the group consisting of direct bond, carbonyl group, alkylene group, divalent aromatic hydrocarbon group, wherein the alkylene group can be interrupted by a carbonyl group,
and wherein, in the structural formulae (III-A), (III-B), (III-C), (III-D), at least one aromatic carbon atom can be substituted with a group selected from alkyl, halogen, alkoxy, OH,
and wherein each n is an integer ≥4,
and wherein the bond marked by “(vi)” binds a repeating unit of the structural formula (III-A), (III-B), (III-C), or (III-D) each to the bond marked by “(vii)” of the adjacent repeating unit.

12. The electrode material according to claim 1, wherein the at least one conductivity additive L is selected from the group consisting of carbon materials, electrically conductive polymers, metals, semimetals, semimetal compounds, metal compounds.

13. The electrode material according to claim 1, wherein the ratio of the total weight of all conductivity additives L to the total weight of all organic redox active polymers P_{Redox} is in the range of 0.1 to 1000 wt. %.

14. The electrode material according to claim 1, comprising at least one ionic liquid IL₁.

15. The electrode material according to claim 14, wherein the ionic liquid IL₁ has the structure Q⁺A⁻, wherein Q⁺ is a cation selected from the group consisting of the following structures (Q1), (Q2), (Q3), (Q4), (Q5): 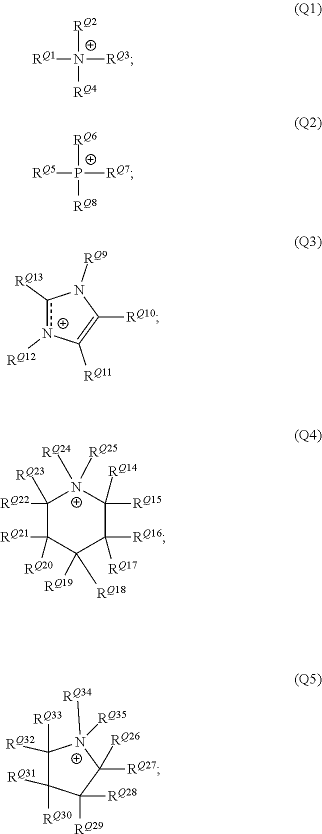
wherein R^{Q1}, R^{Q2}, R^{Q3}, R^{Q4}, R^{Q5}, R^{Q6}, R^{Q7}, R^{Q8} are each independently selected from the group consisting of alkyl group, haloalkyl group, cycloalkyl group,
wherein R^{Q9}, R^{Q10}, R^{Q11}, R^{Q12}, R^{Q13}, R^{Q14}, R¹⁵, R^{Q16}, R^{Q17}, R^{Q18}, R^{Q9}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group, ether group, polyether group, haloalkyl group, cycloalkyl group,
and wherein A⁻ is an anion selected from the group consisting of phosphate, phosphonate, alkylphosphonate, monoalkylphosphate, dialkylphosphate, bis[trifluoromethanesulfonyl]imide, alkylsulfonate, haloalkylsulfonate, alkylsulfate, haloalkylsulfate, bis[fluorosulfonyl]imide, halide, dicyanamide, hexafluorophosphate, sulfate, tetrafluoroborate, trifluoromethanesulfonate, perchlorate, hydrogen sulfate, haloalkylcarboxylate, alkylcarboxylate, formate, bisoxalatoborate, tetrachloroaluminate, dihydrogen phosphate, monoalkylhydrogen phosphate, nitrate.

16. The electrode material according to claim 14, wherein the ionic liquid IL₁ has a melting point ≤100° C.

17. The electrode material according to claim 14, wherein the ratio of the total weight of all ionic liquids IL₁ comprised by the electrode material to the total weight of all organic redox active polymers P_{Redox} comprised by the electrode material is in the range from 0.1 to 1000 wt. %.

18. The electrode material according to claim 1, further comprises at least one solvent selected from the group consisting of water, alcohols, ethers, esters, ketones.

19. An electrode comprising an electrode material according to claim 1 and a substrate.

20. A charge storage device comprising at least one electrode according to claim 19.

21. A charge storage device comprising at least two electrodes and a substrate, wherein at least one of the electrodes comprises the electrode material according to claim 8.

22. The charge storage device according to claim 19, further comprising at least one electrolyte comprising at least one ionic liquid IL₂.

23. (canceled)
